(19) United States
(12) Patent Application Publication
(10) Pub. No.: US 2015/0324302 A1
(43) Pub. Date: Nov. 12, 2015

(54) WHITE BOX ENCRYPTION SYSTEM AND METHOD

(71) Applicant: Electronics and Telecommunications Research Institute, Daejeon (KR)

(72) Inventors: Seung Kwang LEE, Daejeon (KR); Doo Ho CHOI, Chungcheongnam-do (KR); Tae Sung KIM, Daejeon (KR); Kyung Hee OH, Daejeon (KR); Yong Je CHOI, Daejeon (KR); Ju Han KIM, Daejeon (KR); You Sung KANG, Daejeon (KR)

(21) Appl. No.: 14/709,999

(22) Filed: May 12, 2015

(30) Foreign Application Priority Data
May 12, 2014 (KR) 10-2014-0056453

(51) Int. Cl. G06F 12/14; H04L 9/08

(52) U.S. Cl. CPC G06F 12/1408; H04L 9/0847; G06F 2212/1052; H04L 2209/24

(57) ABSTRACT

A white box encryption device is provided. The device included in a second device among a first device and the second device performing wired or wireless communication, and performing an encryption/decryption operation using a white box encryption table consisting of a look-up table set, includes, a non-volatile memory configured to store an incomplete look-up table set in which at least one look-up table or a portion of entire look-up table is removed, a volatile memory configured to store the incomplete look-up table set received from the non-volatile memory and the at least one look-up table received from the first device at a time of the encryption/decryption operation, and construct a complete look-up table set, and an encryption/decryption operation unit configured to perform the encryption/decryption operation using the complete look-up table set.

### CROSS-REFERENCE TO RELATED APPLICATION

This application claims priority to and the benefit of Korean Patent Application No. 10-2014-0056453, filed on May 12, 2014, the disclosure of which is incorporated herein by reference in its entirety.

### BACKGROUND

1. Field of the Invention

The present invention relates to a white box encryption system and method, and more particularly, to a white box encryption system and method for preventing dispossession of a white box encryption table.

2. Discussion of Related Art

Encryption technology is technology of changing plain text into ciphertext.

Black box encryption technology among encryption technologies requires an encryption key in the process of encrypting the plain text. The encryption key included inside the encryption device is assumed to be a black box. Here, in the encryption technology, the black box denotes a box with an invisible inside. That is, a design of a black box-based encryption device starts from an assumption that a cracker cannot see the inside of the encryption device. Accordingly, the cracker can see only the plain text input to the black box-based encryption device and the ciphertext output from the black box-based encryption device.

In the black box-based encryption device, the cracker tries to find any pattern by monitoring two input and output values continuously. When the encryption device itself is hacked, the encryption key can be revealed. When the encryption key is revealed, every encryption procedure is completely disclosed to the cracker.

White box encryption technology is technology which is more advanced than the black box encryption technology. In the encryption technology, the white box may be interpreted as a transparent box. The white box encryption technology starts from an assumption that the inside of the encryption device is visible. When the cracker can see the inside, since the encryption key can be obtained, a designer of the white box encryption technology has to consider more details.

In conventional white box encryption technology, the encryption key is scrambled by a complex encryption operation algorithm. Particularly, the encryption operation algorithm in the white box encryption technology is implemented in the form of an encoded look-up table, the encryption key is scrambled by the encryption operation algorithm having the form of the look-up table. As a result, even when the cracker analyzes an inner operation, the encryption key cannot be easily deduced.

In the white box encryption technology, when constructing the encryption algorithm as one look-up table having a large size, it is easy to hide the encryption key. In this case, the excessively large size of the table is not practical. Accordingly, in the white box encryption technology, decoding and encoding operations are performed so that the large look-up table is properly divided into small look-up tables according to an encryption method and an intermediate value is not revealed in process of performing the encryption operation.

As shown in FIG. 1, in the encryption operation of the white box encryption technology, since the encoding operation (Mi) and the decoding operation (Mi⁻¹) are performed in separate tables, the intermediate value is not revealed, and only an original encryption operation (Xi) is performed while the encryption and decryption operations offset each other. That is, the result value of the encryption operation shown in FIG. 1 is “F¹∘X₁∘X₂∘X₃ ∘ . . . ∘Xᵢ∘G”. The encryption result value is obtained using only the look-up table without revealing the intermediate value. At this time, in order to obtain the correct encryption result value, the plain text is encoded using F, and a final ciphertext has to be decoded using G⁻¹.

As such, in current white box encryption technology, since the encryption key is hidden in the encryption operation algorithm having the form of the look-up table, the encryption key is not revealed.

However, when the white box encryption algorithm itself in which the encryption key is hidden is revealed or the encryption device itself in which the encryption algorithm is stored is stolen, since an attacker possesses the look-up table stored in the encryption device, the encryption/decryption operation can be performed.

### SUMMARY OF THE INVENTION

The present invention is directed to a white box encryption system and method capable of maintaining security and safety even when a device in which a white box encryption operation algorithm in which an encryption key is hidden or a device in which the operation algorithm is stored is stolen.

According to one aspect of the present invention, there is provided a white box encryption device included in a second device among a first device and the second device performing wired or wireless communication, and performing an encryption/decryption operation using a white box encryption table consisting of a look-up table set, including: a non-volatile memory configured to store an incomplete look-up table set in which at least one look-up table or a portion of an entire look-up table is removed; a volatile memory configured to store the incomplete look-up table set received from the non-volatile memory and the at least one look-up table received from the first device at a time of the encryption/decryption operation, and construct a complete look-up table set; and an encryption/decryption operation unit configured to perform the encryption/decryption operation using the complete look-up table set.

According to another aspect of the present invention, there is provided a white box encryption device included in a first device among a first device and the second device performing wired or wireless communication, and performing an encryption/decryption operation using a white box encryption table consisting of a look-up table set, including: a table generation unit configured to generate the look-up table set to which an encryption key for encrypting information obtained by the second device is coupled; an incomplete table generation unit configured to extract at least one look-up table from the look-up table set, and generate an incomplete look-up table set from which the at least one look-up table is removed; and a transmission unit configured to transmit the generated incomplete look-up table set and the at least one removed look-up table to the second device, respectively.

According to still another aspect of the present invention, there is provided a method of performing an encryption/decryption operation using a white box encryption table consisting of a look-up table set, including: receiving an incomplete look-up table set from which at least one look-up table is removed from the look-up table set from a first device, and storing the incomplete look-up table set in a non-volatile storage medium; receiving the at least one look-up table from the first device at a time of performing an encryption/decryption operation; reconstructing a complete look-up table set by inputting the at least one removed look-up table the incomplete look-up table set to a volatile storage medium at the time of performing the encryption/decryption operation; and performing the encryption/decryption using the reconstructed complete look-up table set.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram for describing conventional white box encryption technology;

FIGS. 2 to 5 are diagrams for describing an operation mechanism of a white box algorithm which is applicable to the present invention;

FIG. 6 is a block diagram illustrating a configuration of an entire system according to an embodiment of the present invention;

FIG. 7 is a detailed block diagram illustrating an internal configuration of each of a first device and a second device shown in FIG. 6;

FIGS. 8 to 11 are diagrams for describing an operation of the system shown in FIG. 6; and

FIG. 12 is a flowchart for describing an encryption/decryption operation method using a white box encryption/decryption table according to an embodiment of the present invention.

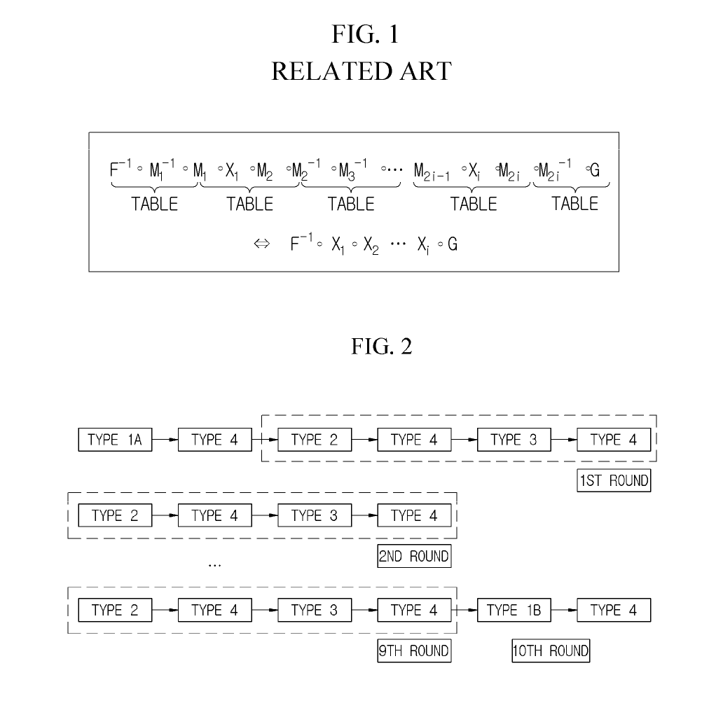

### DETAILED DESCRIPTION OF EXEMPLARY EMBODIMENTS

In the present invention, an attacker can perform an encryption/decryption operation by possessing a set of look-up tables stored in a read only memory (ROM) or a disk when an encryption device in which the set of look-up tables of a white box encryption algorithm is stored is stolen. This is a disadvantage of the white box encryption in which a secret key is coupled to the set of the look-up tables. The present invention provides a method capable of improving the disadvantage.

The above and other objects, features and advantages of the present invention will become more apparent to those of ordinary skill in the art by describing in detail exemplary embodiments thereof with reference to the accompanying drawings. However, the present invention is not limited to the exemplary embodiments which will be described hereinafter, and can be embodied in various different forms. Exemplary embodiments of the present invention are described below in sufficient detail to enable those of ordinary skill in the art to embody and practice the present invention. The present invention is defined only by the appended claims. Through this specification, like reference numerals refer to like components.

When a detailed description with respect to a well-known function or configuration is determined to obscure the gist of the present invention in the following description of the exemplary embodiments of the present invention, a detailed description thereof will be omitted. The terms used hereinafter are defined by considering a function in exemplary embodiments of the invention, and their meaning may be changed according to intentions or customs, etc. of a user, an operator. Accordingly, the terminology will be defined based on the content throughout this specification.

Combinations of each block of a block diagram and each operation of a flowchart which are attached may be performed by the instructions in a computer program. Since the instructions of a computer program can be installed in a processor of a general purpose computer, a specific purpose computer, or other programmable data processing devices, the instructions performed through the processor of the computer or the other programmable data processing devices generates a means for performing functions described in each block of the block diagram or each operation of the flowchart. Since the instructions of a computer program are stored in a computer usable or readable memory capable of supporting the computer or the other programmable data processing devices in order to implement the functions in a specific method, the instructions stored in the computer usable or readable memory produce manufactured products including the instruction means for performing functions described in each block of the block diagram or each operation of the flowchart. Since the instructions of a computer program are installed in the computer or the other programmable data processing devices, a series of operations are performed in the computer or the other programmable data processing devices, a process performed by the computer is generated, and the instructions performing the computer or the other programmable data processing devices can provide operations for performing the functions described in each block of the block diagram and each operation of the flowchart.

Further, each block or each operation may represent a portion of a module, a segment or a code including at least one executable instruction for executing a specific logical function(s). Moreover, it should be noted that the functions described in the blocks or the operations in some alternative embodiments can be performed out of the order shown. For example, two blocks or operations which are sequentially shown can be performed simultaneously, or can be performed in reverse order according to a corresponding function.

Hereinafter, exemplary embodiments of the present invention will be described in detail below with reference to the accompanying drawings.

First, after describing a white box encryption algorithm which is applicable to the present invention with reference to FIGS. 2 to 5, exemplary embodiments of the present invention will be described in detail.

FIGS. 2 to 5 are diagrams for describing an operation mechanism of an advanced encryption standard (AES) algorithm implemented as a principle of a white box which is applicable to the present invention.

The AES algorithm (hereinafter, an algorithm) which is applicable to the present invention may be configured by five look-up tables including Type1A, Type1B, Type2, Type3, and Type4. Input data and output data of each table may be configured so that a table inner operation is easily obscured through a non-linear conversion operation of decoding and encoding by permutating two nibble inputs (4-bit input), respectively.

As shown in FIG. 2, an operation sequence of an algorithm using five tables may consist of 11 rounds including an initial round, a first round to a ninth round, and a final (tenth) round.

In the operation sequence shown in FIG. 2, an operation of the table Type4 table may be performed after performing operations of the tables Type1A, Type1B, Type2, and Type3. An exclusive (XOR) operation for completing a matrix multiplication operation by collecting mixing bijection results performed in the tables Type1A, Type1B, Type2, and Type3 is needed. That is, since the XOR operation is performed in the table Type4, the table Type4 may follow another table.

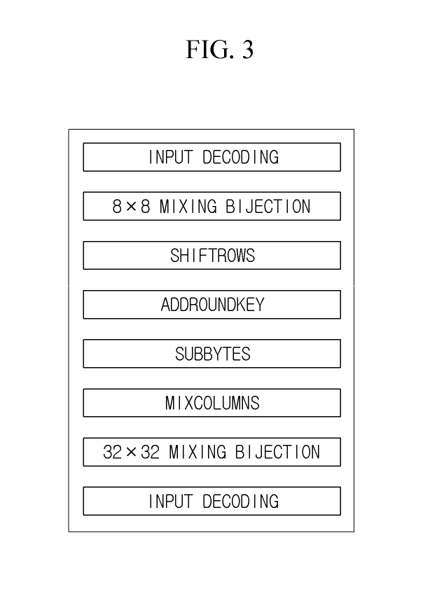

FIG. 3 is a diagram illustrating a structure of a table Type2 among the tables shown in FIG. 2.

Referring to FIG. 3, most of the round operations may be performed in the table Type2. In the table Type2, an 8×8 mixing bijection operation multiplying an 8×8 invertible matrix and a 32 x 32 mixing bijection operation multiplying a 32×32 invertible matrix before/after the round operation may be performed besides a decoding operation of input data and an encoding operation of output data. Intermediate data of the round operation and a key may be safely hidden from the attacker by multiplying the matrix before/after the round operation.

In the table Type3, when every operation of the tables Type2, Type3, and Type4 are performed by multiplying inverse matrices with respect to the 8×8 matrix (8×8 mixing bijection) and the 32×32 matrix (32×32 mixing bijection) multiplied in the table Type2, only the AES round operation may remain.

In order to increase the security of the AES algorithm, an operation of multiplying a 128×8 invertible matrix on the 128-bit input and output data may be performed by the tables 1a and 1b. Further, the table Type1B may perform a final round operation of the AES algorithm in addition to a function of protecting so that the output data described above is not directly revealed.

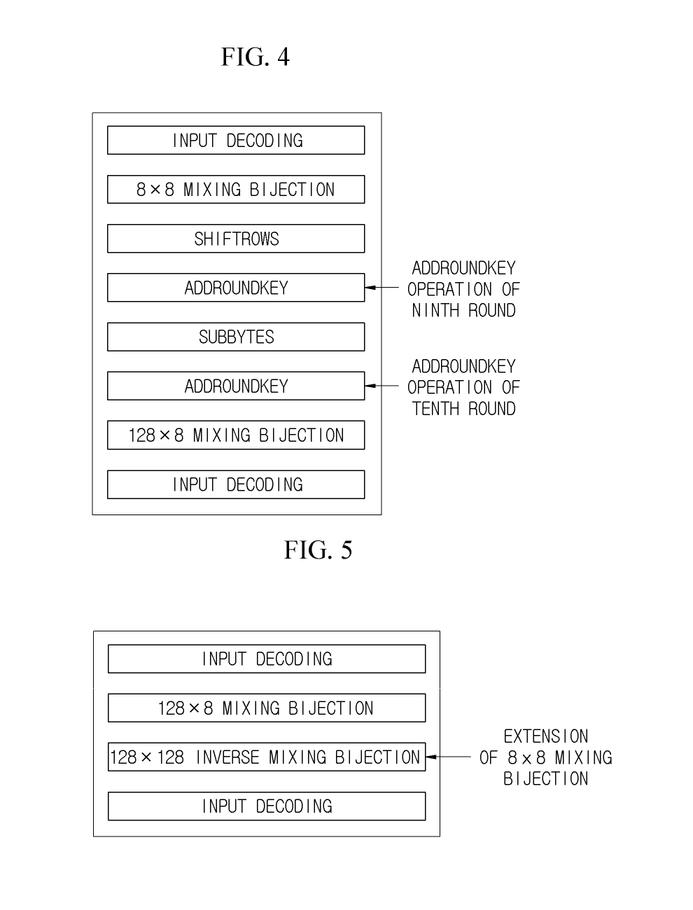

FIG. 4 is a diagram illustrating a structure of a table Type1B among the tables shown in FIG. 2. FIG. 5 is a diagram illustrating a structure of a table Type1B among the tables shown in FIG. 2.

Referring to FIGS. 4 and 5, when performing an encryption operation on 128-bit input data, an encryption operation of the AES algorithm may perform 10 round operations after performing an AddRoundKey operation. In the AES algorithm, since an initial AddRoundKey round operation is performed in the table Type2 performing a first round operation and an AddRoundKey operation of a first round is performed in the table Type2 performing a second round operation, both an AddRoundKey operation of a ninth round and an AddRoundKey operation of a final round may be performed in the table Type1B performing a final round operation.

Further, the 8×8 mixing bijection operation in the table Type1B may be offset by multiplying the 8×8 inverse matrix previously in the table Type3 among the tables in which the ninth round operation is performed and performing an operation of multiplying the 8×8 matrix which is its inverse matrix in the table Type1B. As described above, when performing a function of multiplying the 32×32 inverse matrix and the 8 ×8 inverse matrix in the table Type3, the 32×32 inverse matrix may be a matrix obtained by multiplying an inverse matrix with respect to the 32×32 matrix multiplied in the table Type2 in the same round, and the 8×8 inverse matrix may be a matrix obtained by multiplying an inverse matrix with respect to the 8×8 matrix multiplied in the table Type2 of a next round (the table Type1B of a final round). Further, the inverse matrix with respect to the 8×8 matrix multiplied in the table Type2 in the first round operation may be removed by being offset by the inverse matrix with respect to the 8×8 matrix previously multiplied in the table Type1A.

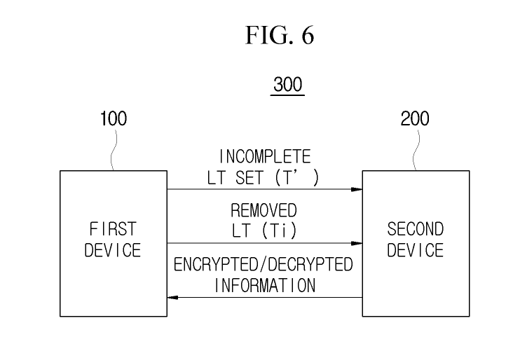

FIG. 6 is a block diagram illustrating a configuration of an entire system according to an embodiment of the present invention.

Referring to FIG. 6, since an entire system 300 according to an embodiment of the present invention may configure the white box algorithm stored in an encryption device as an incomplete look-up table, when an attacker steals the encryption device, an encryption/decryption operation may be fundamentally blocked by the attacker since the attacker possesses the incomplete look-up table.

Accordingly, the entire system 300 according to an embodiment of the present invention may include a first device 100 and a second device 200. Although not particularly limited thereto, it may be assumed that the first device 100 is included in a control system for managing an operation of a unmaned aerial vehicle, and the second device 200 is included in a computing device of the unmaned aerial vehicle.

In the above assumed system, an embodiment of the present invention illustrates a system environment of encrypting information obtained by the unmaned aerial vehicle, and providing the encrypted information to the control system. Here, the information obtained by the unmaned aerial vehicle may include geographical information of a corresponding region which is captured by a photograph and measured weather information such as humidity, temperature, etc., while flying over the corresponding region.

In the system environment described above, each of the first and second devices 100 and 200 may perform the encryption/decryption operation using the white box encryption table including a complete look-up table set.

In order to perform the encryption/decryption operation, the first device 100 may provide the incomplete look-up table set T′ from which at least one look-up table is removed from the complete look-up table set to the second device 200. After this, at a time in which the second device 200 performs the encryption/decryption operation, the first device 100 may provide the at least one look-up table Ti removed from the complete look-up table set to the second device 200.

When assuming the system environment described above, a time at which the first device 100 provides the incomplete look-up table set T′ may be prior to the takeoff of the unmaned aerial vehicle. In contrast, a time at which the first device 100 provides the at least one look-up table Ti may be a time at which the encryption/decryption operation is performed after the unmaned aerial vehicle has taken off.

The second device 200 may receive the incomplete look-up table T′ from the first device 100, and store the incomplete look-up table T′ in a non-volatile storage medium. The second device 200 may receive the at least one look-up table Ti removed from the complete look-up table at the time of the encryption/decryption operation. At this time, the second device 200 may not store the at least one look-up table Ti in the non-volatile storage medium. The second device 200 may reconstruct the complete look-up table set by moving the provided incomplete look-up table T′ and the at least one look-up table Ti provided at the encryption/decryption operation time to a volatile storage medium included therein in order to perform the encryption/decryption operation. Accordingly, the complete look-up table set may be maintained only while power supply to the volatile storage medium is maintained, and may be erased when the power supply is cut off.

When the unmaned aerial vehicle including the second device 200 crashes due to a failure, the power supply to the unmaned aerial vehicle may be stopped. This may mean that the power supply to the volatile storage medium is blocked. Accordingly, the complete look-up table set stored in the volatile storage medium may be erased. As a result, even when the second device is not stolen in a state in which the power supply to the second device is maintained, leakage of the complete look-up table set stored in the second device may be blocked fundamentally.

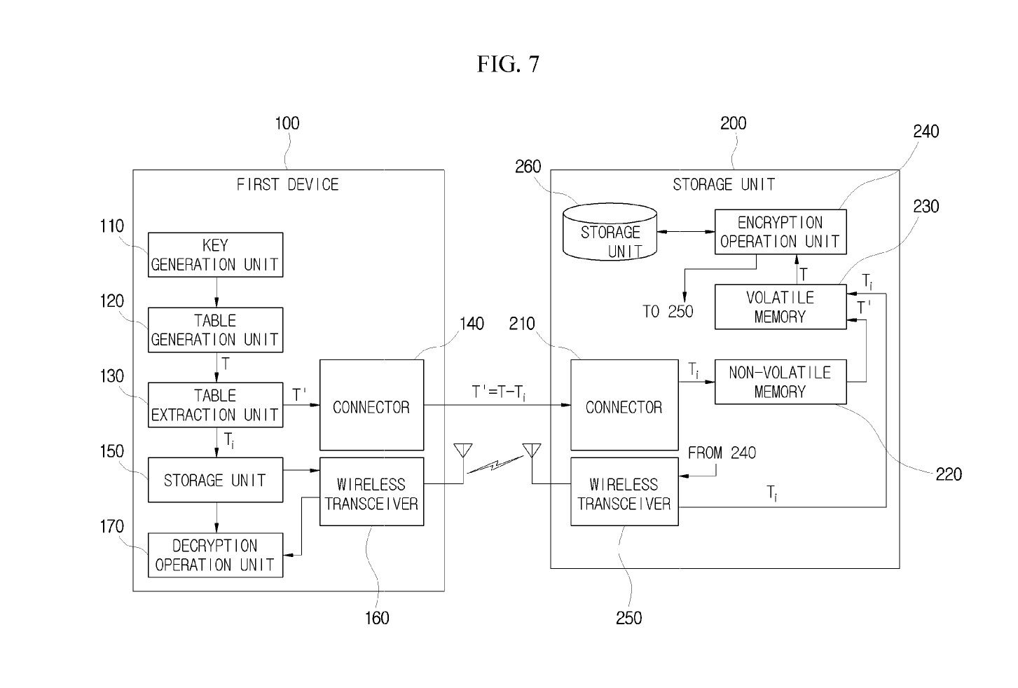

Hereinafter, each of the first device and the second device will be described in detail with reference to FIG. 7.

FIG. 7 is a detailed block diagram illustrating a configuration of each of a first device and a second device shown in FIG. 6.

Referring to FIG. 7, the first device 100 may provide the incomplete look-up table set to the second device 200. For this, the first device may include a key generation unit 110, a table generation unit 120, a table extraction unit 130, a connector 140, a storage unit 150, a wireless transceiver 160, and a decryption operation unit 170.

The key generation unit 110 may generate a secret key for encrypting information obtained by the second device 200.

The table generation unit 120 may receive the secret key, and generate a look-up table set T including a plurality of look-up tables based on the received secret key. For convenience of explanation, the look-up table set T generated by the table generation unit 120 may be referred to as a complete look-up table set.

The table extraction unit 130 may receive the complete look-up table set, and extract at least one look-up table Ti from the received complete look-up table set.

The at least one look-up table which is extracted may be stored in the storage unit 150. The at least one look-up table stored in the storage unit 150 may be transmitted to the second device 200 through the wireless transceiver 160 when the encryption/decryption operation is performed by the second device 200.

The look-up table set including the remaining look-up tables excluding the extracted look-up table may be transmitted to the connector 140. For convenience of explanation, the look-up table set excluding the extracted look-up table may be referred to as an incomplete look-up table set T′ (=T−Ti).

The incomplete look-up table set T′ may be transmitted to the second device 200 through the connector 140 before a time of the encryption/decryption operation performed by the second device 200. For example, the incomplete look-up table set T′ may be transmitted to the second device 200 through the connector 140 before the unmaned aerial vehicle including the second device 200 takes off.

The decryption operation unit 170 may receive encrypted information from the second device 200 through the wireless transceiver 160, and decrypt the received encrypted information using the white box encryption algorithm.

The second device 200 may encrypt information using the incomplete look-up table received from the first device 100. For this, the second device 200 may include a connector 210, a non-volatile memory 220, a volatile memory 230, an encryption operation unit 240, a wireless transceiver 250, and a storage unit 260.

The connector 210 may receive the incomplete look-up table T′ through the connector 140 of the first device 100.

The non-volatile memory 220 may receive the incomplete look-up table T′ transmitted from the connector 210. For example, the non-volatile memory 220 may be a read only memory (ROM) or a hard disk for maintaining information even when the power supply is cut off.

The volatile memory 230 may receive and store the incomplete look-up table T′ stored in the non-volatile memory 220 and a portion of the look-up table removed from the complete look-up table set T received through the wireless transceiver 250 at the encryption/decryption operation time. At this time, the portion of the look-up table transmitted from the first device may be transmitted in an encrypted form, and for this, the encryption key may be generated through the incomplete look-up table T′ shared between the first device 100 and the second device 200.

Accordingly, the complete look-up table set T may be reconstructed in the volatile memory 220. At this time, when the power supply by the power supply unit stops, the complete look-up table T reconstructed in the volatile memory 220 may be erased. When the unmaned aerial vehicle crashes due to a failure, the power supply by the power supply unit may be stopped. In this case, since the complete look-up table set T reconstructed in the volatile memory 220 is erased when the power supply is stopped, leakage of the complete look-up table set T may be blocked even when an attacker possesses the non-volatile memory 220 of the second device 200.

The encryption operation unit 240 may perform an operation of encrypting information stored in the storage unit 260 with reference to the complete look-up table reconstructed in the volatile memory 230. Here, the encrypted information may include geographical information of a corresponding region which is captured by a photograph and measured weather information such as humidity, temperature, etc., while flying over the corresponding region.

The information encrypted by the encryption operation unit 240 may be transmitted to the wireless transceiver of the first device 100 through the wireless transceiver 250, and the wireless transceiver of the first device 100 may transmit the information to the decryption operation unit 170. The decryption operation unit 170 of the first device 100 may decrypt the encrypted information transmitted from the second device 200.

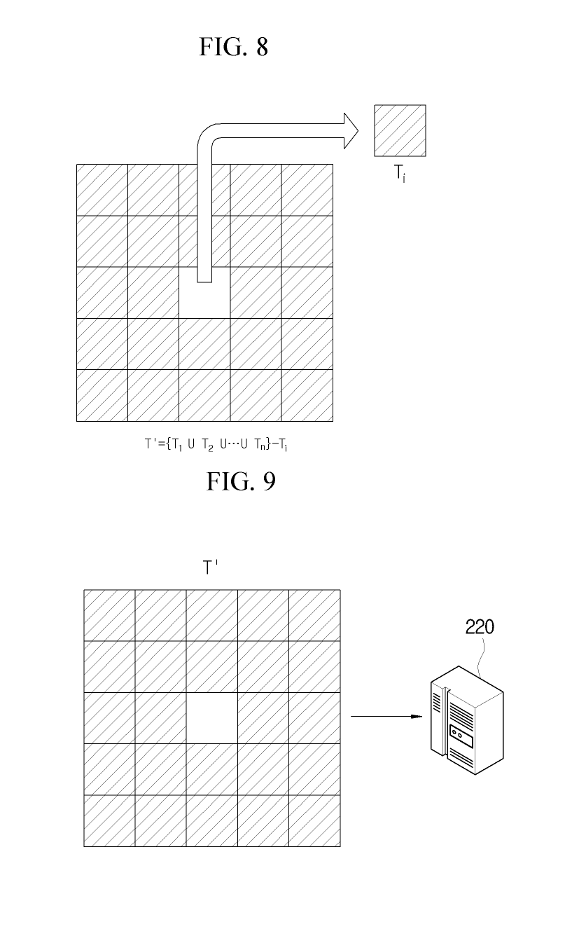

FIGS. 8 to 11 are diagrams for describing an operation of the system shown in FIG. 6, for convenience of explanation, the operation will be described with reference to FIG. 7

First, in the first device 100, the complete look-up table set T by which the encryption operation or the decryption operation can be performed based on a synthetic function of a white box encryption algorithm may be generated. Assuming that the number of look-up tables is n, T may be expressed as the following Equation 1.

T=T₁∪T₂∪. . . ∪Tₙ [Equation 1]

Referring to FIG. 8, when the complete look-up table set T is generated, at least one look-up table or a portion of the look-up table Ti among the look-up tables included in the complete look-up table set T may be extracted from the complete look-up table T. The incomplete look-up table set T′ in which the at least one look-up table Ti is removed may be expressed as the following Equation 2.

T′=T−Tᵢ [Equation 2]

Referring to FIG. 9, the incomplete look-up table T′ generated in the first device 100 may be transmitted to the second device 200, and the second device 200 may store the incomplete look-up table T′ in the non-volatile memory 220 such as a ROM. At this time, the at least one look-up table Ti extracted in the first device 100 may be stored in the storage unit 150 of the first device 100.

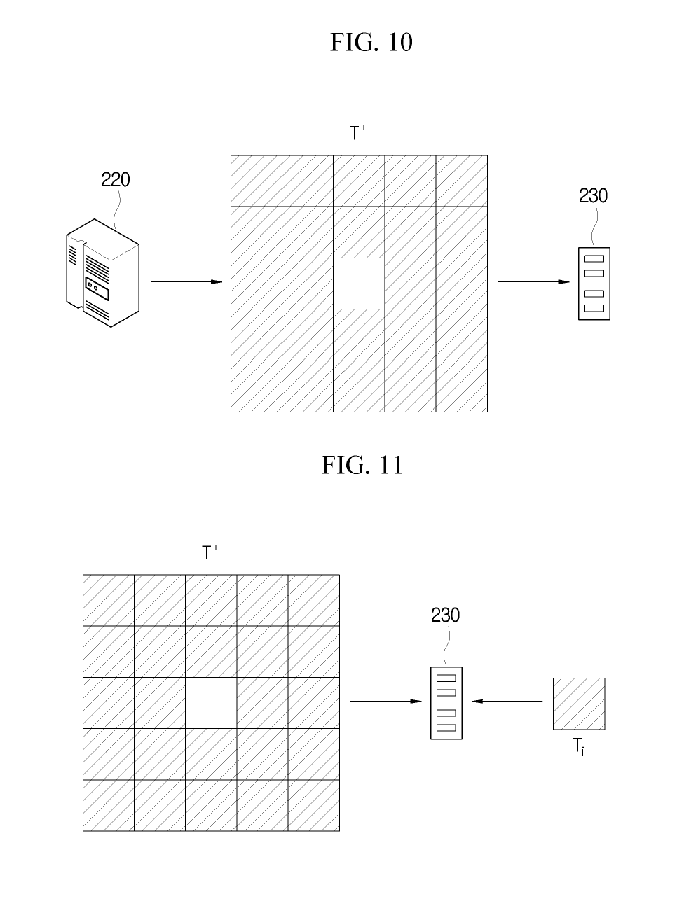

Referring to FIG. 10, in order to perform the encryption/decryption operation in the second device 200, the incomplete look-up table T′ may be stored in the volatile storage medium such as a random access memory (RAM). Accordingly, the incomplete look-up table T′ may be moved from the non-volatile memory 220 to the volatile memory 230 before the encryption/decryption operation is performed. At this time, since T′ is the incomplete look-up table, the at least one look-up table Ti extracted in the first device 100 may be needed in order to output a correct encryption/decryption text.

Referring to FIG. 11, the second device 200 may not store the at least one look-up table Ti extracted in the first device 100 in the non-volatile storage medium at a time of the encryption/decryption operation, and fetch the at least one look-up table Ti from the volatile memory 230 of the second device 200 in order to output the correct encryption/decryption text. Accordingly, the complete look-up table T may be present in the volatile memory 230 of the second device 200 in order to perform the correct encryption/decryption operation.

When the volatile memory 220 is the RAM, the complete look-up table T may be maintained only when the power supply is maintained from the power supply unit, and may be erased when the power supply is cut off.

Accordingly, even when the second device 200 is not stolen in a state in which the power supply is maintained from the power supply unit to the second device 200, the leakage of the complete look-up table set T may be blocked. Particularly, an environment in which the second device 200 is installed in the unmaned aerial vehicle, the leakage of the completed look-up table set T may be fundamentally blocked.

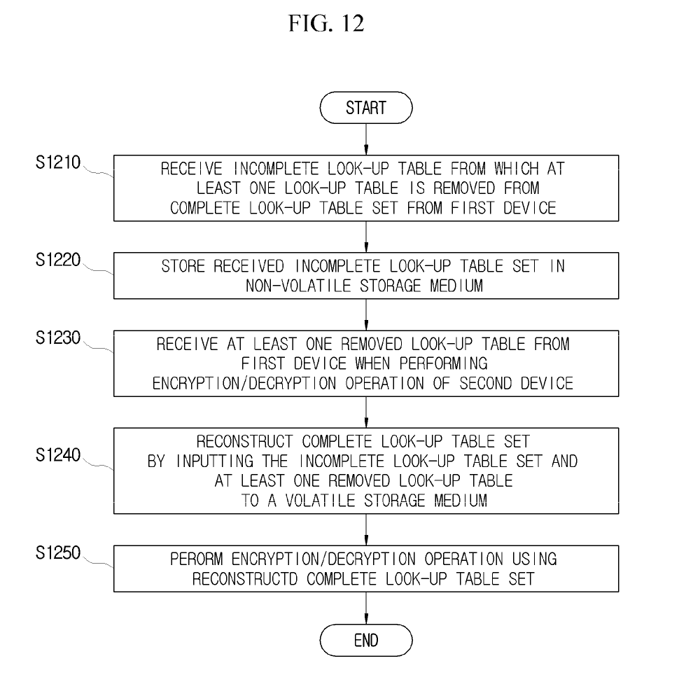

FIG. 12 is a flowchart for describing an encryption/decryption operation method using a white box encryption/decryption table according to an embodiment of the present invention.

Referring to FIG. 12, in operation 1210, an operation of receiving the incomplete look-up table set from which at least one look-up table is removed from the complete look-up table set from the first device may be performed. In operation 1220, an operation of storing the received incomplete look-up table set in the non-volatile storage medium of the second device may be performed. In operation 1230, an operation of receiving the at least one removed look-up table from the first device when performing the encryption/decryption operation of the second device may be performed. In operation 1240, an operation of reconstructing the complete look-up table set by storing the at least one removed look-up table in the volatile storage medium may be performed. In operation 1250, an operation of performing the encryption/decryption using the reconstructed complete look-up table set may be performed.

As described above, the secret key may be coupled to the look-up table set of the conventional white box encryption algorithm, and when the encryption device (or the second device) storing the look-up table set is stolen, the look-up table set may be revealed to the attacker, and the attacker may perform the encryption/decryption operation.

On the other hand, in the present invention, the encryption device may possess the incomplete look-up table set, the complete look-up table set may be reconstructed by coupling with the look-up table input from an external device (or the first device) when performing the encryption/decryption operation, and the encryption/decryption operation may be performed. At this time, since there is the reconstructed complete look-up table in the volatile storage medium of the encryption device (or the second device), the encryption device which is stolen in a state that the power supply is cut off may provide only the incomplete look-up table to the attacker. Accordingly, the security and safety can be maintained even when the encryption device (or the second device) is stolen.

According to the present invention, the white box encryption device may possess the incomplete look-up table set, receive the removed look-up table from the outside at a time of performing the encryption/decryption operation, construct the complete look-up table set, and perform the encryption/decryption operation using the constructed complete look-up table set. At this time, the complete look-up table set may be constructed in the volatile storage medium. When the white box encryption device is stolen in a state that the power supply to the volatile storage medium is cut off, the complete look-up table set constructed in the volatile storage medium may be erased. Accordingly, since the attacker possesses the incomplete look-up table set, the attacker cannot perform the encryption/decryption operation.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A white box encryption device included in a second device among a first device and the second device performing wired or wireless communication, and performing an encryption/decryption operation using a white box encryption table consisting of a look-up table set, comprising:
a non-volatile memory for storing an incomplete look-up table set in which at least one look-up table is removed;
a volatile memory for constructing a complete look-up table set by storing the incomplete look-up table set inputted from the non-volatile memory and the at least one look-up table received from the first device at a time of the encryption/decryption operation; and
an encryption/decryption operation unit for performing the encryption/decryption operation using the complete look-up table set.

2. The white box encryption device of claim 1, wherein, when power supply to the volatile memory is blocked, the complete look-up table set constructed in the volatile memory is erased.

3. The white box encryption device of claim 1, further comprising a reception unit configured to communicate with the first device through the wired or wireless communication, and
wherein the reception unit receives the incomplete look-up table set from the first device, and stores the incomplete look-up table set to the non-volatile memory.

4. The white box encryption device of claim 3, wherein the reception unit receives the at least one look-up table from the first device through the wireless communication at the time of the encryption/decryption operation, and outputs the at least one look-up table to the volatile memory.

5. The white box encryption device of claim 1, wherein the second device is a computing device implemented in a unmaned aerial vehicle.

6. A white box encryption device included in a first device among a first device and the second device performing wired or wireless communication, and performing an encryption/decryption operation using a white box encryption table consisting of a look-up table set, comprising:
a table generation unit configured to generate the look-up table set to which an encryption key for encrypting information obtained by the second device is coupled;
an incomplete table generation unit configured to extract at least one look-up table from the look-up table set, and generate an incomplete look-up table set from which the at least one look-up table is removed; and
a transmission unit configured to separately transmit the generated incomplete look-up table set and the at least one removed look-up table to the second device.

7. The white box encryption device of claim 6, wherein the first device is implemented in an controlling system controlling an air traffic of a unmaned aerial vehicle.

8. The white box encryption device of claim 6, wherein the transmission unit transmits the at least one removed look-up table to the second device at a time of performing the encryption/decryption operation in the second device.

9. A device-to-device (D2D) system performing an encryption/decryption operation using a white box encryption table consisting of a look-up table set, comprising:
a first device configured to extract at least one look-up table from the look-up table set, and generate an incomplete look-up table set from which the at least one look-up table is removed; and
a second device configured to receive the incomplete look-up table set from the first device according to a wired or wireless communication method, store the incomplete look-up table set in a non-volatile memory included therein, receive the at least one look-up table from the first device at a time of an encryption/decryption operation, construct a complete look-up table set by moving the at least one received look-up table and the incomplete look-up table set stored in the non-volatile memory to a volatile memory included therein, and perform the encryption/decryption operation with respect to specific information using the constructed complete look-up table set.

10. The device-to-device (D2D) system of claim 9, wherein, when power supply to the volatile memory is blocked, the complete look-up table set constructed in the volatile memory is erased.

11. A method of performing an encryption/decryption operation using a white box encryption table consisting of a look-up table set, comprising:
receiving an incomplete look-up table set from which at least one look-up table is removed from the look-up table set from a first device, and storing the incomplete look-up table set in a non-volatile storage medium;
receiving the at least one look-up table from the first device at a time of performing an encryption/decryption operation;
reconstructing a complete look-up table set by inputting the at least one removed look-up table and the incomplete look-up table to a volatile storage medium to a volatile storage medium at the time of performing the encryption/decryption operation; and
performing the encryption/decryption using the reconstructed complete look-up table set.

12. The method of performing the encryption/decryption operation of claim 11, wherein, when power supply to the volatile memory is blocked, the complete look-up table set is erased.

13. The method of performing the encryption/decryption operation of claim 11, wherein a second device is included in a computing device implemented in a unmaned aerial vehicle.
